(19) United States
(12) Patent Application Publication
(10) Pub. No.: US 2026/0250950 A1
(43) Pub. Date: Aug. 27, 2026

(54) HIGH IMPACT AND PENETRATION RESISTANT LIGHTWEIGHT COMPOSITE PANELS AND SHEATHING

(71) Applicant: HYDROBLOK, INC., Park City, UT (US)

(72) Inventors: Brian DUNN, Draper, UT (US); Alex GILLESPIE, Draper, UT (US)

(21) Appl. No.: 19/552,867

(22) Filed: Feb. 27, 2026

Related U.S. Application Data
(60) Provisional application No. 63/764,354, filed on Feb. 27, 2025.

(51) Int. Cl. E04C 2/288; B32B 5/02; B32B 5/18; B32B 5/24; B32B 13/02; B32B 27/06; B32B 27/12; E04B 2/00; E04B 5/02

(52) U.S. Cl. CPC E04C 2/288; B32B 5/024; B32B 5/028; B32B 5/18; B32B 5/245; B32B 13/02; B32B 27/065; B32B 27/12; B32B 2250/05; B32B 2250/40; B32B 2264/10; B32B 2307/7376; B32B 2307/744; B32B 2607/00; E04C 2/46; E04C 2/50

(57) ABSTRACT

High impact and penetration resistant lightweight composite panels include a foam core and an impact and penetration resistant protective layer on at least a portion of the lightweight composite panel. The foam core is a polymer and/or inorganic foam layer or sheet having first and second surfaces. A fiber mesh reinforced cementitious layer can cover one or both surfaces of the foam core. Example polymer foam cores include extruded polystyrene foam, expanded polystyrene foam, polyisocyanurate foam, or polyurethane foam. Example inorganic foam cores include perlite, ceramic microspheres, hollow glass spheres, glass foam, ceramic foam, expanded silica gel, porous wollastonite, urea-silicate foam, SiOC/SiC foam, refractory foam, and graphene. The impact and penetration resistant protective layer can be formed from polyurea, polyurethane, polyurea-polyurethane hybrid, polyaspartic, polymer-modified mineral binder, or hybrid resin-mineral composite. The protective layer can include a tightly woven scrim and/or a slip resistant filler embedded in the polymer.

### CROSS-REFERENCE TO RELATED APPLICATION

This application claims the benefit of U.S. Provisional Application No. 63/764,354, filed Feb. 27, 2025, which is incorporated by reference in its entirety

### BACKGROUND

### Technical Field

This disclosure relates to high impact and penetration resistant lightweight composite panels and sheathing and methods of making and using such panels and sheathing.

### Related Technology

Houses and other buildings are typically constructed using wood or metal studs to form a three-dimensional wall frame, which can include an interior wall on one side and an exterior wall on the other. Alternatively, both sides can be interior walls, such as interior walls separating rooms or walls dividing attached dwelling units such as apartments, town houses, and condominiums. In some cases, both sides can be exterior walls, such as fences, screen walls, sound barriers, walls that partially enclose carports, dumpster surrounds, and the like.

Interior walls of houses and other buildings are typically formed using drywall (e.g., gypsum board) to form a generally flat underlying wall surface, which can be painted, wallpapered, or treated with other desired finishes. A drywall panel typically consists of a layer of gypsum plaster sandwiched between two layers of paper. While suitable for walls which are not exposed to water, drywall is not suitable for applications exposed to water and high humidity environments. For applications where walls will be exposed to moisture, such as in bathrooms, particularly showers and bathtubs, cement board is typically used.

Exterior walls have their own unique challenges. In general, exterior walls are typically formed by fastening sheathing, typically wooden boards, to form exterior walls, followed by the application of a waterproof membrane, followed by the application of one or more surface finishes, most of which require several steps and layers. The most common wooden sheeting used to make exterior walls are oriented strand board (“OSB”) panels because of their favorable cost and combination of materials properties. OSB panels are typically used to form outer walls to which desired finishing elements can be attached, such as stucco, bricks, stone, panels, fixtures, and the like.

OSB panels are not waterproof but prone to swelling, rotting, and developing mold and mildew if exposed to water over time. They are typically wrapped with a waterproof polymer membrane to keep external water from contacting the OSB panels. Another issue is that OSB panels are flammable and emit toxic gases when ignited, such as during house fire. Moreover, burning OSB panels emit embers that can quickly spread and ignite other fires.

In general, composite panels can be used in construction, industrial, and commercial applications due to their lightweight structure and versatility. However, many traditional panels lack impact resistance, abrasion durability, waterproofing, and slip-resistant properties, making them unsuitable for high-stress, high-traffic, or moisture-prone environments. Common solutions, such as laminates, paints, or additional reinforcing layers, can improve durability but often result in increased weight, added complexity in installation, and higher costs. There is a need for a high-performance composite panel that offers enhanced protection while remaining lightweight and increasing aesthetic value.

Accordingly, there is a need for improved lightweight panels that provide high impact and penetration resistance and that are lightweight and more easily handled and installed compared to heavy plywood, oriented strand boards (OSB), gypsum boards, and cement boards that can reduce time, weight, and labor costs, and provide improved moisture resistance.

### SUMMARY

Disclosed are composite panels and sheaths that are impact-resistant, penetration-resistant, lightweight, waterproof, durable, and easy to handle and install. In some embodiments, lightweight composite panels and sheaths include an impact and penetration resistant protective layer applied to one or more surfaces of a lightweight foam core, partially covering or fully encapsulating the foam core. In some embodiments, the impact and penetration resistant protective layer can include embedded fabric or scrim to provide improved impact and penetration resistance (e.g., when the lightweight composite panels are used as structural sheathing). In some embodiments, the impact and penetration resistant protective layer can include one or more non-slip additives (e.g., when the lightweight composite panels are used as flooring or other generally horizontal or ramped surface).

The protective layer(s) can form a seamless, high-strength, protective layer, significantly improving impact resistance, penetration resistance, waterproofing, and abrasion resistance. In some embodiments, the protective layer can provide a textured, non-slip surface for enhanced safety in industrial, construction, and recreational applications. The high impact and penetration lightweight composite panels and sheaths can form a system designed for industrial, architectural, automotive, and general-purpose applications, where durability, shear strength, lightweight construction, and/or slip prevention are important. Sheathing systems made using high impact and penetration resistant lightweight composite panels can be used for building envelope assemblies requiring enhanced resistance to high-velocity impact, cyclic wind loading, projectile penetration, and multi-hazard exposure conditions.

In some embodiments, a high impact and penetration resistant lightweight composite panel or sheath comprises:
a polymer and/or inorganic foam core having a first surface, a second surface opposite the first surface, and a thickness in a range of about 0.4 cm to about 5 cm, or about 0.8 cm to about 4 cm, or about 1.5 cm to about 2 cm; and
an impact and penetration resistant protective layer on or positioned over at least one of the first surface or the second surface of the foam core, the impact and penetration resistant protective layer comprising:
   at least one protective material selected from thermoset polymer, polyaspartic, polyurea, polyurethane, polyurea-polyurethane hybrid, polymer-modified mineral binder, hybrid resin-mineral composite, and mineral binder; and
   optionally a tightly woven fabric or scrim at least partially embedded within the protective material, provided that where the protective material is a mineral binder, the tightly woven fabric or scrim is included,
wherein the impact and penetration resistant protective layer has a thickness in a range of about 1 mm to about 10 mm, or about 1.25 mm to about 8.75 mm, or about 1.5 mm to about 7.5 mm, or about 2 mm to about 6 mm.

In some embodiments, the foam core can be a polymer form core, such as an extruded polystyrene (XPS) sheet for lightweight, moisture-resistant performance, polyisocyanurate foam, polyurethane (PUR) foam for added impact absorption and thermal resistance, phenolic polymer (e.g., phenol-formaldehyde) foam, melamine polymer (e.g., melamine-formaldehyde) foam, expanded polystyrene (EPS) for low cost, lightweight applications, and/or other thermoplastic or thermoset polymer known in the art that can be formed into rigid or semi-rigid foam layers.

In some embodiments, the foam core can be an inorganic foam core, which comprises one or more porous inorganic materials, such as a refractory foam material, to provide additional fire-resistance. Examples include expanded perlite (e.g., expanded spheres or microspheres), vermiculite, pumice, ceramic microspheres, hollow glass spheres, glass foam, ceramic foam, expanded silica gel, aerogel, other silicate foams, porous wollastonite, metakaolin, urea-silicate foam, SiOC/SiC foam, refractory foams, graphene, and the like. The inorganic foam core can resist melting even when exposed to fire or intense heat in order for the lightweight composite panel to maintain its structural integrity.

In some embodiments, the impact and penetration resistant protective layer includes a protective material that is a curable (e.g., multi-part) polymer coating that partially or fully covers over the first and/or second surfaces of the foam core, including covering at least the exterior surface of the lightweight composite panel to provide high impact and penetration resistance. In some embodiments, an impact and penetration resistant protective coating may fully encapsulate the foam core and any fiber mesh reinforced cementitious layer(s). In some embodiments, the impact and penetration resistant polymer layer(s) can comprise one or more of polyurea, polyurethane (PUR), polyurea-polyurethane hybrid, polyaspartic, polymer-modified mineral binder, or hybrid resin-mineral composite, providing high adhesion, flexibility, and resistance to cracking or delamination similar to coatings used a as protective truck bed liners. In some embodiments, an impact and penetration resistant polymer layer can be applied in multiple coating steps to form multiple sub-layers to increase impact and penetration resistance and strength.

In some embodiments, the impact and penetration resistant protective layer may include a tightly woven fabric or scrim at least partially embedded within the protective material, provided that where the protective material is a mineral binder, the tightly woven fabric or scrim is included. The fabric or scrim may include alkali-resistant (AR) fiberglass, high-count fiberglass, AR polyester, aramid fibers (including para-aramid such as Kevlar®), ultrahigh molecular weight polyethylene (UHMW-PE) fibers, poly(p-phenylene-2,6-benzobisoxazole (PBO) fibers (e.g., Zylon®), carbon fibers, high tenacity nylon (polyamide), or hybrid fiber architectures with multiple fiber types as disclosed or known in the art. The scrim weave may further incorporate embedded ribs, spacer structures, multi-axial reinforcement, or ballistic-enhancing geometries to improve energy dissipation and penetration resistance.

In some embodiments, the final impact and penetration resistant protective layer can create a seamless, waterproof, and impact and penetration resistant barrier that enhances durability. The impact and penetration resistant polymer coating may include a slip resistant filler, such as silica granules, aluminum oxide grit, rubberized particles, or highly textured embedded scrim to provide a textured, slip-resistant surface for increased traction and safety.

In some embodiments, the high impact and penetration resistant lightweight composite panel comprises a fiber mesh reinforced cementitious layer formed over and covering at least a portion of the first surface or the second surface of the foam core, optionally beneath one or more impact and penetration resistant protective layers. In some embodiments, an impact and penetration resistant protective layer can be formed on the first surface of the foam core and a fiber mesh reinforced cementitious layer can be formed on the second surface of the foam core. In other embodiments, In other embodiments, a first fiber mesh reinforced cementitious layer can be formed on the first surface of the foam core, an impact and penetration resistant protective layer can be formed over the first fiber mesh reinforced cementitious layer, a second fiber mesh reinforced cementitious layer can be formed on the second surface of the foam core, and optionally a second impact and penetration resistant protective layer can be formed over the second fiber mesh reinforced cementitious layer.

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates a high impact and penetration resistant lightweight composite panel or sheath with an example impact and penetration resistant protective layer that can be applied over and cover at least one surface of a lightweight foam core;

FIG. 2A is a side perspective view that illustrates examples of differently-sized high impact and penetration resistant lightweight composite panels or sheaths;

FIG. 2B is a top perspective view that illustrates the differently-sized high impact and penetration resistant lightweight composite panels or sheaths of FIG. 7A;

FIG. 2C is an exploded view diagram that schematically illustrates the layered structure of the high impact and penetration resistant lightweight composite panels or sheaths of FIGS. 2A and 2B.

### DETAILED DESCRIPTION

### I. Introduction

Disclosed are high impact and penetration resistant lightweight composite panels and sheaths that are lightweight, waterproof, durable, and easy to handle and install. In some embodiments, lightweight composite panels and sheaths include an impact and penetration resistant protective layer applied to one or more surfaces of a lightweight foam core, partially covering or fully encapsulating the foam core. In some embodiments, the impact and penetration resistant protective layer can include embedded fabric or scrim to provide improved impact and penetration resistance (e.g., when the lightweight composite panels are used as structural sheathing). In some embodiments, the impact and penetration resistant protective layer can include one or more non-slip additives (e.g., when the lightweight composite panels are used as flooring or other generally horizontal or ramped surface).

The protective layer(s) can form a seamless, high-strength, protective layer, significantly improving impact resistance, penetration resistance, waterproofing, and abrasion resistance. In some embodiments, the protective layer can provide a textured, non-slip surface for enhanced safety in industrial, construction, and recreational applications. The high impact and penetration lightweight composite panels and sheaths can form a system designed for industrial, architectural, automotive, and general-purpose applications, where durability, shear strength, lightweight construction, and/or slip prevention are important. Sheathing systems made using high impact and penetration resistant lightweight composite panels can be used for building envelope assemblies requiring enhanced resistance to high-velocity impact, cyclic wind loading, projectile penetration, and multi-hazard exposure conditions.

Additional information relating to lightweight composite panels generally, modifications thereof, and various uses in making interior walls and exterior walls is disclosed in U.S. application Ser. No. 19/306,608, filed Aug. 21, 2025. Additional information relating to lightweight composite panels that include a plaster show layer (e.g., for interior walls) is disclosed in U.S. application Ser. No. 19/306,817, filed Aug. 21, 2025. Additional information relating to lightweight composite panels that include a paper facer (e.g., for interior walls) is disclosed in U.S. application Ser. No. 19/343,312, filed Sep. 29, 2025. Additional information relating to lightweight composite panels that include a cured polymer show layer (e.g., for interior walls) is disclosed in U.S. application Ser. No. 19/343,601, filed Sep. 29, 2025. Additional information relating to lightweight composite panels and their use as substrates in making exterior walls with various applied finishes is disclosed in U.S. application Ser. No. 19/307,007, filed Aug. 21, 2025. Additional information relating to lightweight composite panels and their use as structural sheathing (e.g., for exterior walls and roofing decks) is disclosed in U.S. application Ser. No. 19/306,800, filed Aug. 21, 2025. Additional information relating to lightweight composite panels with a pre-applied drainage layer and their use in making exterior walls is disclosed in U.S. application Ser. No. 19/306,608, filed Aug. 21, 2025. Additional information relating to lightweight composite panels and their use in making subfloors and ceiling systems is disclosed in U.S. application Ser. No. 19/307,024, filed Aug. 21, 2025. Additional information relating to lightweight composite panels and their use in making two-sided wall structures is disclosed in U.S. application Ser. No. 19/388,771, filed Nov. 13, 2025. Additional information relating to the use of lightweight composite panels to construct shaft liners (e.g., for elevator shafts, stairwells, or mechanical chases) is disclosed in U.S. application Ser. No. 19/454,347, filed Jan. 20, 2026. Additional information relating to lightweight composite panels that include an inorganic foam core and one or more protective layers is disclosed in U.S. application Ser. No. 19/454,140, filed Jan. 20, 2026. The foregoing applications are incorporated by reference in their entirety.

### II. High Impact and Penetration Resistant Lightweight Composite Panels

In some embodiments, a high impact and penetration resistant lightweight composite panel or sheath comprises:
a polymer and/or inorganic foam core having a first surface, a second surface opposite the first surface, and a thickness in a range of about 0.4 cm to about 5 cm; and
an impact and penetration resistant protective layer on or positioned over at least one of the first surface or the second surface of the foam core, the impact and penetration resistant protective layer comprising:
   at least one protective material selected from thermoset polymer, polyaspartic, polyurea, polyurethane, polyurea-polyurethane hybrid, polymer-modified mineral binder, hybrid resin-mineral composite, and mineral binder; and
   optionally a tightly woven fabric or scrim at least partially embedded within the protective material, provided that where the protective material is a mineral binder, the tightly woven fabric or scrim is included,
wherein the impact and penetration resistant protective layer has a thickness in a range of about 1 mm to about 10 mm.

In some embodiments, the foam core can be a polymer form core, such as an extruded polystyrene (XPS) sheet for lightweight, moisture-resistant performance, polyisocyanurate foam, polyurethane (PUR) foam for added impact absorption and thermal resistance, phenolic polymer (e.g., phenol-formaldehyde) foam, melamine polymer (e.g., melamine-formaldehyde) foam, expanded polystyrene (EPS) for low cost, lightweight applications, and/or other thermoplastic or thermoset polymer known in the art that can be formed into rigid or semi-rigid foam layers.

In some embodiments, the foam core can be an inorganic foam core, which comprises one or more porous inorganic materials, such as a refractory foam material, to provide additional fire-resistance. Examples include expanded perlite (e.g., expanded spheres or microspheres), vermiculite, pumice, ceramic microspheres, hollow glass spheres, glass foam, ceramic foam, expanded silica gel, aerogel, other silicate foams, porous wollastonite, metakaolin, urea-silicate foam, SiOC/SiC foam, refractory foams, graphene, and the like. The inorganic foam core can resist melting even when exposed to fire or intense heat in order for the lightweight composite panel to maintain its structural integrity.

The foam core can have a thickness suitable for an intended purpose, such as being in a range of about 0.4 cm to about 5 cm, or about 0.5 cm to about 4.5 cm, or about 0.75 cm to about 4 cm, or about 1 cm to about 3.5 cm, or about 1.5 cm to about 3 cm.

In some embodiments, the impact and penetration resistant protective layer includes a protective material that is a curable (e.g., multi-part) polymer coating that partially or fully covers over the first and/or second surfaces of the foam core, including covering at least the exterior surface of the lightweight composite panel to provide high impact and penetration resistance. In some embodiments, an impact and penetration resistant protective coating may fully encapsulate the foam core and any fiber mesh reinforced cementitious layer(s). In some embodiments, the impact and penetration resistant polymer layer(s) can comprise one or more of polyurea, polyurethane (PUR), polyurea-polyurethane hybrid, polyaspartic, polymer-modified mineral binder, or hybrid resin-mineral composite, providing high adhesion, flexibility, and resistance to cracking or delamination similar to coatings used a as protective truck bed liners. In some embodiments, an impact and penetration resistant polymer layer can be applied in multiple coating steps to form multiple sub-layers to increase impact and penetration resistance and strength.

In some embodiments, the impact and penetration resistant protective layer may include a tightly woven fabric or scrim at least partially embedded within the protective material, provided that where the protective material is a mineral binder, the tightly woven fabric or scrim is included. “Tightly woven” refers to fabrics, materials, or structures constructed with threads or components packed closely together with minimal gaps. This creates a dense, strong, and often opaque material, such as denim or percale, that resists tearing, holds its shape well, and is durable. It implies high thread count and structural integrity. A tightly woven fabric will not show light through it when held up, and distinct gaps between individual threads generally cannot be seen.

The fabric or scrim may include alkali-resistant (AR) fiberglass, high-count fiberglass, AR polyester, aramid fibers (including para-aramid such as Kevlar®), ultrahigh molecular weight polyethylene (UHMW-PE) fibers, poly(p-phenylene-2,6-benzobisoxazole (PBO) fibers (e.g., Zylon®), carbon fibers, high tenacity nylon (polyamide), or hybrid fiber architectures with multiple fiber types as disclosed or known in the art. The scrim weave may further incorporate embedded ribs, spacer structures, multi-axial reinforcement, or ballistic-enhancing geometries to improve energy dissipation and penetration resistance.

In some embodiments, the final impact and penetration resistant protective layer can create a seamless, waterproof, and impact and penetration resistant barrier that enhances durability. The impact and penetration resistant polymer coating may include a slip resistant filler, such as silica granules, aluminum oxide grit, rubberized particles, or highly textured embedded scrim to provide a textured, slip-resistant surface for increased traction and safety.

The impact and penetration resistant protective layer comprises or can be formed by spray-coating one or multiple layers of a curable composition (e.g., polyurea, polyurethane, or hybrid thereof) to form one or multiple layers of thermoset polymer (e.g., 1 to 5 layers). Each of the one or more thermoset polymer layers can have a thickness of about 0.75 mm to about 2 mm, or about 1 mm to about 1.75 mm, or about 1.25 mm to about 1.5 mm. The thickness of the impact and penetration resistant polymer coating can be about 0.75 mm to about 10 mm, or about 1 mm to about 8.75 mm, or about 1.5 mm to about 7.5 mm, or about 2 mm to about 6 mm.

In some embodiments, the impact and penetration resistant protective layer includes a protective material that is a curable (e.g., multi-part) polymer coating that partially or fully covers over the first and/or second surfaces of the foam core, including covering at least the exterior surface of the lightweight composite panel to provide high impact and penetration resistance. In some embodiments, an impact and penetration resistant protective coating may fully encapsulate the foam core and any fiber mesh reinforced cementitious layer(s). In some embodiments, the impact and penetration resistant protective layer(s) can comprise one or more of polyurea, polyurethane (PUR), polyurea-polyurethane hybrid, polyaspartic, polymer-modified mineral binder, or hybrid resin-mineral composite, providing high adhesion, flexibility, and resistance to cracking or delamination similar to coatings used as protective truck bed liners. Alternatively, the impact and penetration resistant protective layer can include a mineral binder with embedded tightly woven scrim or fabric.

In some embodiments, the high impact and penetration resistant lightweight composite panel comprises a fiber mesh reinforced cementitious layer formed over and covering at least a portion of the first surface or the second surface of the foam core, optionally beneath one or more impact and penetration resistant protective layers. In some embodiments, an impact and penetration resistant protective layer can be formed on the first surface of the foam core and a fiber mesh reinforced cementitious layer can be formed on the second surface of the foam core. In other embodiments, In other embodiments, a first fiber mesh reinforced cementitious layer can be formed on the first surface of the foam core, an impact and penetration resistant protective layer can be formed over the first fiber mesh reinforced cementitious layer, a second fiber mesh reinforced cementitious layer can be formed on the second surface of the foam core, and optionally a second impact and penetration resistant protective layer can be formed over the second fiber mesh reinforced cementitious layer.

In some embodiments, lightweight composite panels that include one or more high impact and penetration resistant protective layers can are strong and can support relatively heavy loads, such as a floor finish and loads typically borne by floors, such as people, furniture, and appliances. The lightweight composite panels are lightweight yet waterproof, mold resistant, heat resistant, and fire resistant, and have high structural strength (i.e., high tensile and flexural strength and high toughness). The lightweight composite panels can be cut, drilled, and screwed, fastened and/or glued onto wall and floor support structures. They can be used for exterior sheathing for buildings and shear walls.

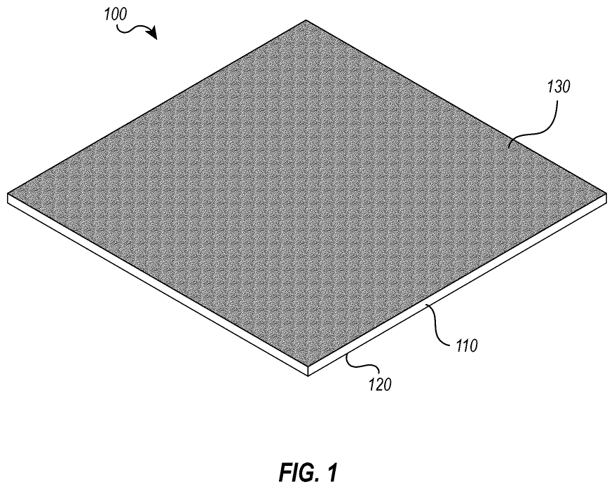

Reference is now made to FIG. 1, which illustrates an example high impact and penetration resistant lightweight composite panel 100, which includes a polymer and/or inorganic foam core 120 including first and second surfaces, an impact and penetration resistant protective layer 130 positioned over the first surface of the foam core 110, and a second protective layer 120 positioned over the second surface of the foam core 120. The second protective layer 120 can also comprise an impact and penetration resistant protective material or it can comprise a fiber mesh reinforced cementitious layer. The impact and penetration resistant protective layer 130 can be formed over an intermediate fiber mesh reinforced cementitious layer (not shown).

In some embodiments, the process of forming the impact and penetration resistant protective layer can be similar to applying a bed liner for a pickup truck (e.g., Rhino Linings®). In such embodiment, a two-part composition is fed to a spray nozzle, which mixes the components to form a curable composition and discharges the curable composition as a spray using pressurized air or other pressurizing means, such as a piston. One part of the two-part composition can be an isocyanate, and the other part can be a resin comprising a diol and/or a diamine and other components that provide the sprayable mixture and finished product with desired properties. The components react together and form a thermoset polymer having high impact-resistance and other desired protective properties (e.g., penetration resistance, particular if a tightly woven scrim or other fabric is at least partially embedded in the polymer material). Example thermoset polymers include, but are not limited to, polyurea, polyurethane (PUR), polyurea-polyurethane hybrids, and polyaspartic.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The amine-terminated polymer resins do not have any intentional hydroxyl moieties. Any hydroxyls are the result of incomplete conversion to the amine-terminated polymer resins. The resin blend may also contain additives or non-primary components. These additives may contain hydroxyls, such as pre-dispersed pigments in a polyol carrier. Normally, the resin blend does not contain a catalyst. This is because the reaction between an isocyanate and amine is extremely fast and hence does not need catalysis.

The chemical structure of polyurea is as follows:

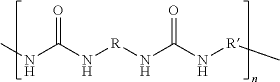

In a polyurea, alternating monomer units of isocyanates and amines react with each other to form urea linkages, as shown below.

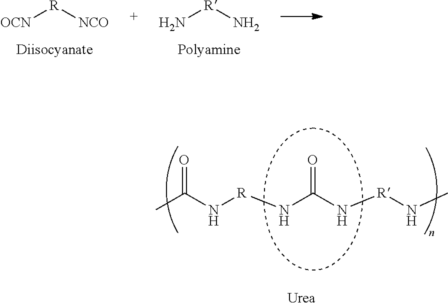

In a polyurethane, alternating monomer units of isocyanates and diols react with each other to form urethane linkages, as shown below.

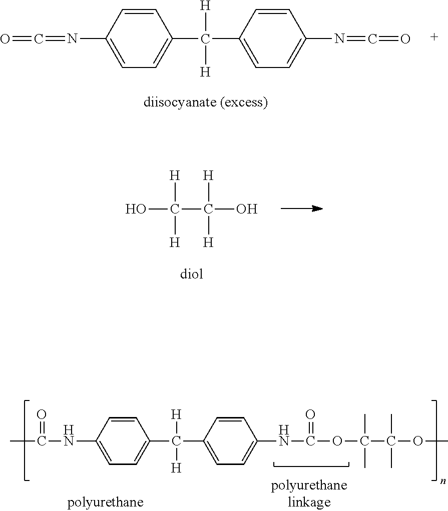

As can be imagined, a polyurea-polyurethane hybrid thermoset polymer can be formed by blending an isocyanate with both a diamine and a diol.

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

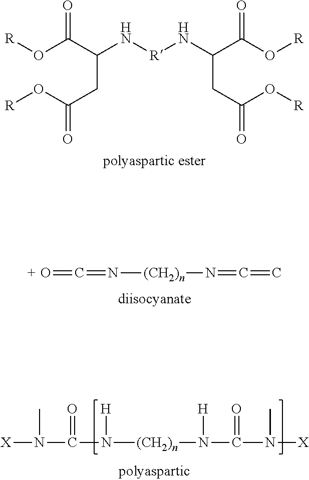

The impact and penetration resistant protective layer can be applied to some or all of the foam core in one or more coats, depending on the intended use and desired level of impact and penetration resistance. More coats provide greater impact and penetration resistance but also increase the weight of the high impact and penetration resistant lightweight composite panels and sheaths. Thus, the optimal number of coats will depend on whether they can resist impacts and/or penetration for their intended use. In general, the impact and penetration resistant layer can include any desired number of coats of impact and penetration resistant material, from 1 coat up to about 10 coats. In general, the total number of coats will range from 1 to 5 coats.

The lightweight composition panels or sheaths includes a foam core and an impact and penetration resistant protective layer formed over one or both surfaces of the foam core, optionally with an intermediate or underlying fiber mesh reinforced cementitious layer on one or both surfaces of the foam core. However, one or both cementitious layers can be partially or entirely omitted if desired. The impact and penetration resistant protective layer can provide strength and durability in addition to and/or in place of the fiber mesh reinforced cementitious layer(s). In some embodiments, the impact and penetration resistant protective layer can be applied (e.g., spray coated) onto a top or exposed surface of the foam core (or underlying fiber mesh reinforced cementitious layer) requiring high impact-resistance. Applying one or more layers of impact and penetration resistant protective material over the top of a fiber mesh reinforced cementitious layer provides the greatest overall impact-resistance compared to applying the impact and penetration resistant protective material directly to an exposed surface of the foam core. On the other hand, even when the lightweight composite panel includes a fiber mesh reinforced cementitious layer on one or both surfaces, the lightweight composite panel will typically include a side perimeter surface of uncoated foam. In such cases, applying the impact and penetration resistant protective material over both the fiber mesh reinforced cementitious layer on the working surface and the side perimeter surfaces enhances the look and durability of the high impact and penetration resistant lightweight composite panels and sheaths and helps prevent delamination.

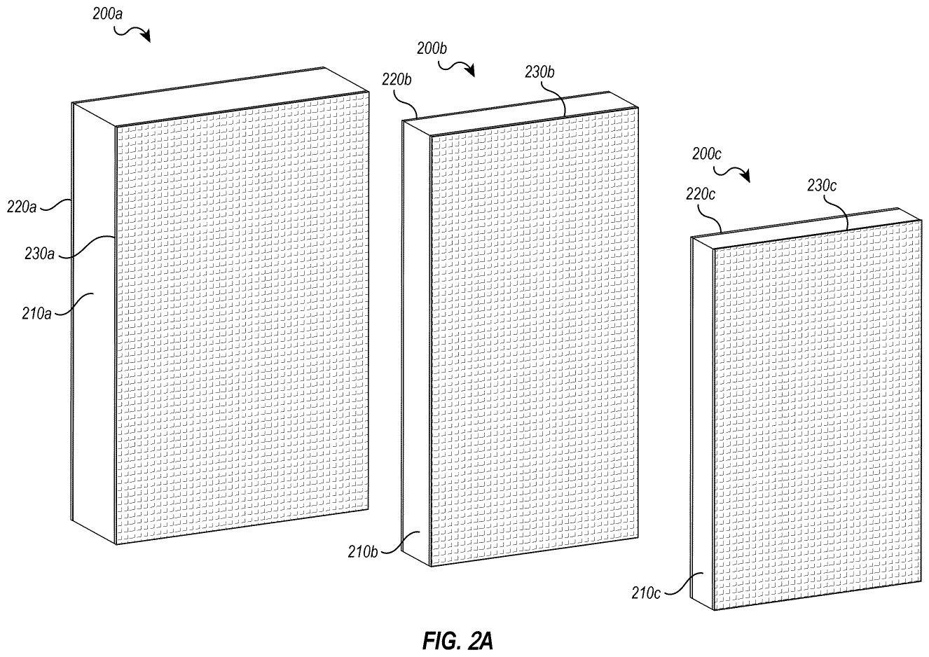

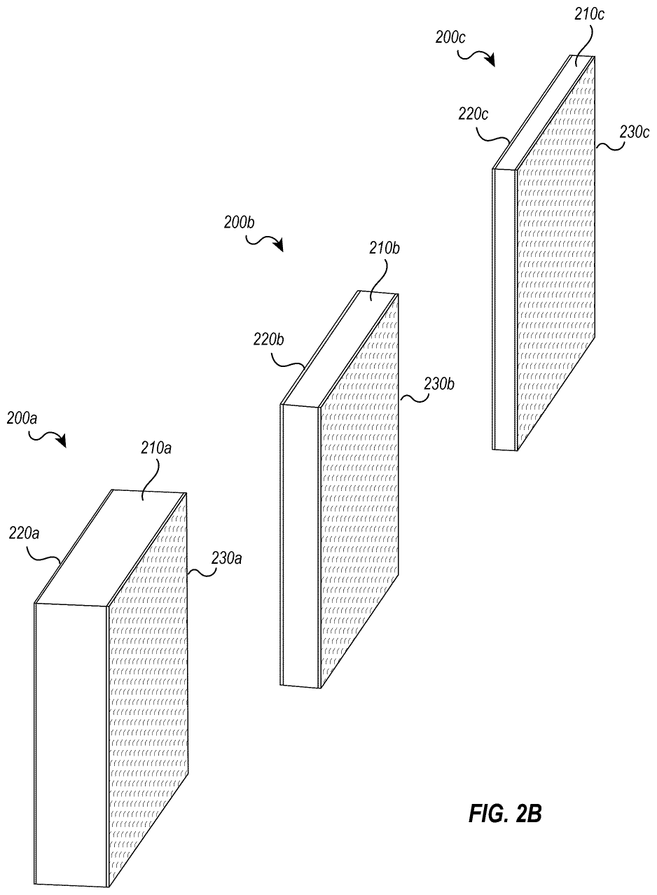

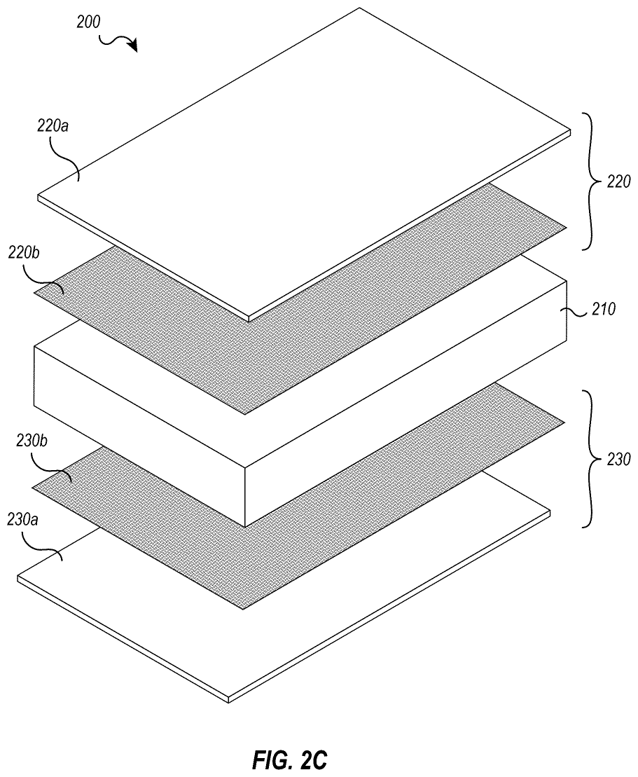

FIGS. 2A and 2B illustrate examples of lightweight composite panels 200a, 200b, 200c of varying cross-sectional thickness that include and/or onto which one or more coats of protective material can be applied to form the impact and penetration resistant protective layer(s). FIGS. 2A and 2B show the layered structure of the lightweight composite panels 200a, 200b, 200c, including strong, lightweight, and moisture-resistant polymer or inorganic foam cores 210a, 210b, 210c sandwiched between first fiber mesh reinforced cementitious layers 220a, 220b, 220c and second fiber mesh reinforced cementitious layers 230a, 230b, 230c.

The cross-sectional thickness of the lightweight composite panels 200a, 200b, 200c can be selected based on a combination of desired properties for their intended use, such as strength, insulation, spacing between wall elements, and the like, including whether they will bear heavy loads, such as when used as flooring in buildings or garages. As illustrated in FIGS. 2A and 2B, the cross-sectional thicknesses of the lightweight composite panels 200a, 200b, 200c varies mostly or entirely depending on the cross-sectional thickness of the foam cores 210a, 210b, 210c. Although not shown, when lightweight composite panels 200 of greater cross-sectional thickness are desired, it may be desirable to increase the thickness of the fiber mesh reinforced cementitious layers 220, 230 (e.g., to account for possible strength reduction caused by including a foam core 210 of greater cross sectional thickness). On the other hand, increased strength can be provided by including or applying a thicker impact and penetration resistant protective layer on one or both sides.

FIG. 2C is in an exploded view that schematically illustrates the layered structure of a lightweight composite panel 200, which is similar or identical to the lightweight composite panels 200a, 200b, 200c of FIGS. 2A and 2B. The foam core 210 can be a lightweight polymer foam made from closed cell extruded polystyrene (XPS), is lightweight, rigid, waterproof, thermally insulating, and includes two outer surfaces or faces. In some embodiments, the foam core 710 (e.g., XPS) may have a density of about 30-45 kg/m³ and a compressive strength of about 250-400 kPa.

Alternatively, the foam cores 110, 210a, 210b, 210c discussed above can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 110, 210 are set forth in Tables 1-3.

TABLE 1

| Property | XPS/EPS | Phenolic | |
|---|---|---|---|
| Material Type | Thermoplastic | Thermoset (phenol- | |
| | polystyrene | formaldehyde) | |
| Thermal Conductivity (W/m · K) | 0.028-0.033 | 0.018-0.022 | |
| R-Value per inch | ~5.0 | 6.5-7.2 | |
| Fire Resistance | Poor - melts, drips | Excellent - chars, low | |
| | | smoke | |
| Flame Spread (ASTM E84) (W/O Facer | 75-200 | <25 (Class A) | |
| Smoke Development (W/O Facer) | >450 (often) | <50 | |
| Thermal Stability | ~93° C. (melts) | 150-175° | C. |
| Water Resistance | Excellent | Good (closed-cell) | |
| Compressive Strength | 200-300 kPa | 100-150 | kPa |

| | | |
|---|---|---|
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR | |
|---|---|---|---|
| Material Type | Thermoset (melamine- | Thermoset (polyol + | |
| | formaldehyde) | isocyanate) | |
| Thermal Conductivity (W/m · K) | 0.032-0.036 | 0.020-0.025 | |
| R-Value per inch | ~4.1-4.5 | ~6.0-6.5 | |
| Fire Resistance | Excellent - non- | Poor - needs FR | |
| | melting, self- | additives | |
| | extinguishing | | |
| Flame Spread (ASTM E84) (W/O Facer | <25 (Class A) | Varies (often >25) | |
| Smoke Development (W/O Facer) | Very low | High | |
| Thermal Stability | ~240° C. | ~100-120° | C. |
| Water Resistance | Poor unless sealed | Good | |
| Compressive Strength | Low | 150-300 | kPa |

| | | |
|---|---|---|
| Flexural Strength | Very brittle | Strong |
| Recyclability | Limited | No |
| Weight (kg/m³) | 7-12 | 30-45 |
| Cost | High | Moderate |

TABLE 3

| Property | Polyiso | |
|---|---|---|
| Material Type | Thermoset (polyisocyanurate) | |
| Thermal Conductivity (W/m · K) | 0.020-0.023 | |
| R-Value per inch | ~6.0-6.5 | |
| Fire Resistance | Good - chars, often Class A | |
| | with facer | |
| Flame Spread (ASTM E84) (W/O Facer | <25 (Class A with facer) | |
| Smoke Development (W/O Facer) | <150 | |
| Thermal Stability | ~150° | C. |
| Water Resistance | Fair (can degrade if | |
| | unprotected) | |
| Compressive Strength | 140-200 | kPa |

| | |
|---|---|
| Flexural Strength | Moderate |
| Recyclability | Rarely recycled |
| Weight (kg/m³) | 30-42 |
| Cost | Moderate-High |

With reference to FIG. 2C, formed over first and second outer surfaces of the foam core 210 are first and second layers of fiber (e.g., fiberglass) mesh 220b, 230b, respectively, which become embedded within respective first and second layers of fresh cementitious or other protective composition applied over the fiber mesh layers 220b, 230b, which harden or cure to form first and second cementitious or other protective layers 220a, 230a. Together, the hardened cementitious or other protective layers 220a, 230a and embedded fiberglass mesh layers 220b, 230b form first and second fiber mesh reinforced cementitious or other protective layers 220, 230, which adhere to the foam core 210 to form a strong but lightweight composite panel structure. The fiber mesh layers 220b, 230b can alternatively include other fibers or filaments, such as carbon fibers or filaments.

It will be understood that the fiber mesh reinforced cementitious layers are optional and can be replaced with impact and penetration resistant protective layers, with the first and second layers of fiber (e.g., fiberglass) mesh 220b, 230b being replaced with tightly woven scrim or fabric.

The foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include expanded perlite (e.g., expanded spheres or microspheres), vermiculite, pumice, ceramic microspheres, hollow glass spheres, glass foam, ceramic foam, expanded silica gel, aerogel, other silicate foams, porous wollastonite, metakaolin, urea-silicate foam, SiOC/SiC foam, refractory foams, graphene, and the like. The inorganic foam core can resist melting even when exposed to fire or intense heat in order for the lightweight composite panel to maintain its structural integrity. The inorganic foam core may include optional reinforcement fibers (cellulosic, basalt, E-glass, or carbon), and optional additives including hydrophobes, biocides, and phase-change or intumescent materials.

In some embodiments, the inorganic foam core is made from a moldable inorganic material that can be formed into inorganic foam sheets or boards. For example, inorganic particles such as expanded perlite, vermiculite, foamed glass particles, pumice, ceramic microspheres expanded silica gel, other inorganic foam particles, and combinations thereof can be blended with a binder material and formed into sheets. In some embodiments, a multi-binder matrix can be formed from one or more of: (i) sodium or potassium silicate solution; (ii) reactive siloxane or organosilane resin; (iii) geopolymeric aluminosilicate binder; (iv) magnesium oxide; (v) urea and polyurea; (vi) hydraulic binder or latent hydraulic setting agents, including calcium aluminate, calcium silicate, magnesium oxychloride, magnesium phosphate, or calcium sulfate hemihydrate; or (vii) bitumen (which provides high hydrophobicity and water resistance, e.g., <0.1% water absorption).

In some embodiments, a mixture of inorganic particles and silicate binder solution, such as an alkali silicate solution (e.g., sodium silicate and/or potassium silicate), optionally in combination with magnesium oxide, a reactive siloxane or organosilane resin and/or with other binder system disclosed herein, are formed into extruded or molded sheets or boards and caused or allowed to dry and cure (e.g., by forming bonds between the inorganic particles and binder materials). The binder network is typically formed through one or more curing mechanisms—such as dehydration, condensation, carbonation, or crosslinking—depending on composition.

Alternatively, the inorganic particles can be mixed with an organic binder, such as a thermoplastic polymer or thermoset resin, and formed into a sheet, which is then allowed to harden by cooling or thermoset curing. Example organic binders include, but are not limited to, polystyrene, polyisocyanurate polyurethane, phenolic polymers (e.g., phenol-formaldehyde), melamine polymers (e.g., melamine-formaldehyde), urethane foam made from methylene diphenol diisocyanate (MDI), polyolefins, polyesters, polyamides, polyether ether ketones (PEEK), (meth)acrylates, polycarbonates, and/or other thermoplastic and thermoset polymers known in the art.

In some embodiments, the inorganic foam core of lightweight composite panels can be manufactured by blending one or more inorganic particles as disclosed herein with a binder system to form a moldable material, forming the moldable material into a sheet, causing or allowing the binder system to solidify to form an inorganic foam core.

In some embodiments, lightweight composite panels are manufactured by applying a fiber (e.g., fiberglass) mesh or tightly woven scrim or fabric and cementitious or curable resin composition onto at least one surface of the foam core and causing or allowing the cementitious or curable resin composition to harden. The fiber mesh or tightly woven scrim or fabric can be embedded in the cementitious or curable resin composition to enhance strength, increase toughness, and prevent cracking.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, or about 1-2 mm in cross-sectional thickness). They are lightweight yet are fire and heat resistant, waterproof, resistant to mold growth, and have high structural strength (i.e., high tensile and flexural strength and high toughness). The fiber mesh component is typically fiberglass fiber or glass filament mesh, but can be made of other strong fibers or filaments, such as carbon fibers or filaments. The lightweight foam core is typically made from extruded polystyrene foam (XPS), but can alternately comprise expanded polystyrene foam (EPS), polyisocyanurate foam, polyurethane foam, silicate foam, or other inorganic foam.

In some embodiments, a fresh cementitious composition comprises mixture products of hydraulic cement, silicon dioxide powder (fine aggregate), calcium oxide (mineral additive), iron oxide (mineral additive), plaster of Paris (gypsum hemihydrate), water-reducing agent (chemical admixture), defoamer (chemical admixture), styrene (chemical admixture), and acrylic acid (chemical admixture). The hydraulic cement typically includes Portland cement, but may also include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The fresh cementitious composition may include other components, such as natural hydraulic lime, calcium silicate, and/or expanded glass, which can increase fire and heat resistance.

In a more particular embodiment, the cementitious composition applied to the outer surfaces of the foam core to form fiber mesh reinforced cementitious layers of the lightweight composite panels can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (16-20%, preferably 18.4% |
| | dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The silicon dioxide fine aggregate can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer can be polydimethylsiloxane (Me₃SiO(Me₂SiO)nSiMe₃) (Me=methyl). In the case where very fine SCMs (e.g., silica fume, microsilica, or metakaoline), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong lightweight composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaoline on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the lightweight composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the lightweight composite panel structure. The result is a layered composite structure, with an interior polymer or inorganic foam sheet, an underlying layer of cementitious composition in direct contact with the foam sheet, a fiberglass mesh in the middle, and a top layer of cementitious composition covering the fiberglass mesh.

In some embodiments, the fiber mesh reinforced cementitious layers of the lightweight composite panels can have a grid-like pattern or texture (or other uneven pattern) that can facilitate adhesion of the impact and penetration resistant polymer coating, as well as structural and/or decorative materials on an uncoated side, such as floor joists, beams, furring strips, insulating foam boards, sheathing of an intermediate underlayment, and floor finishes.

In addition to, or instead of, a fiber mesh reinformed cementitious layer, one or both protective layers of the lightweight composite panel may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

When a tightly woven scrim or fabric is used instead of the fiber mesh, it may be desirable to apply a first layer of fresh cementitious or curable polymer material onto a surface of the foam care, followed by applying the tightly woven scrim or fabric over the first layer of fresh cementitious or curable polymer material, followed by applying a second layer of fresh cementitious or curable polymer material over the tightly woven scrim or fabric. A roller and/or doctor blade can be used to improve penetration into and/or bonding of the fresh cementitious or curable polymer material to the tightly woven scrim or fabric.

In some embodiments, the impact and penetration resistant polymer or other protective coating may be applied either during manufacture of the lightweight composite panels or sheaths or after installation of the panels or sheaths at a job site, including application to exposed surfaces, edges, seams, or fastener locations.

The high impact and penetration resistant lightweight composite panels can be fastened to a support structure (e.g., wall, floor joists, or concrete underlayment) using fasteners known in the art, such as screws, rivets, adhesives, and other fastening means. In some embodiments, an adhesive, such as construction adhesive, can be used to adhere lightweight composite panels to the support structure, including to studs or directly to a subfloor or wall framework, either in addition to or instead of screws or other mechanical fasteners. An adhesive can provide a more continuous bond interface between lightweight composite panels and joists, beams, furring strips, or sheathing, thereby distributing the load more evenly and improving shear strength of the subfloor and prevent floor creaking. The use of adhesive attachment in addition to or instead of screws can eliminate discrete attachment points, creating a more solid and continuous bond that can better resist lateral forces and improve strength of the subfloor structure.

### III. Properties and Other Attributes

Following are additional properties and attributes of the disclosed high impact and penetration resistant lightweight composite panels.

### A. Representative Application Environments

### 1. Hurricane and Coastal Windborne Debris Regions

Applicable in coastal and island regions subject to hurricane-force winds and windborne debris impact, including but not limited to Florida, Gulf Coast states, Caribbean territories, and Pacific island regions. The system is designed to resist cyclic pressure loading and projectile impacts consistent with large and small missile test protocols used in high-velocity hurricane zones (HVHZ).

### 2. Tornado and Extreme Wind Zones

Applicable in tornado-prone regions including the Midwestern and Central United States, where structures are exposed to high-velocity rotating wind fields and debris impact. The reinforced composite facer and energy-absorbing core are configured to dissipate impact energy and mitigate breach under extreme transient loading.

### 3. Hail-Prone Regions

Applicable in areas subject to severe hail events, including Texas, Colorado, and other high-plains regions. The composite structure is designed to resist repeated high-energy point impacts while minimizing surface fracture, delamination, or core crushing.

### 4. Ballistic and Shrapnel Resistance Applications

Applicable to structures requiring enhanced resistance to ballistic fragments, blast debris, or shrapnel, including municipal facilities, embassies, military installations, hardened storage facilities, and protective infrastructure in conflict-prone regions. The hybrid scrim configurations and spacer geometries may be optimized for controlled energy dispersion and projectile deceleration.

### 5. Disaster Response, Temporary Housing, and Life-Safety Structures

Applicable to rapidly deployable shelters, FEMA-style temporary housing, modular units, and disaster-relief infrastructure intended for use before, during, and after natural disasters. The integrated thermal insulation and impact and penetration resistant characteristics provide both environmental protection and structural hardening within a lightweight, transportable assembly.

### 6. Critical Infrastructure and Public Safety Facilities

Applicable to schools, hospitals, safe rooms, data centers, and emergency operations facilities requiring enhanced envelope resilience without the weight and cost associated with traditional concrete or steel armor systems.

B. Functional Advantages Supporting these Applications

The composite system:
Dissipates kinetic energy through fiber-reinforced matrix cracking control and tensile redistribution.
Resists penetration through high-tensile scrim architectures and optional multi-axial reinforcement.
Mitigates spall and fragmentation via encapsulated mesh geometries.
Provides continuous insulation while enhancing structural envelope hardening.
Maintains lightweight constructability relative to conventional concrete or steel armor solutions.
Allows integration into prefabricated or modular wall assemblies.
   C. Spray-Applied Impact and Penetration Resistant Coating with Non-Slip Additives:
A high-performance, protective coating applied as a uniform layer over one or more panel surfaces or fully encapsulating the panel.
The coating can be a polyurethane, polyurea, hybrid blend, or polyaspartic, providing high adhesion, flexibility, and resistance to cracking or delamination similar to coatings used to protect truck bed liners.
The final coating creates a seamless, waterproof, and impact and penetration resistant barrier that enhances durability.
Non-slip additives, such as silica granules, rubberized particles, or aluminum oxide grit, can be incorporated to provide a textured, slip-resistant surface suitable for applications requiring extra traction.

### D. Application Methodology:

High-pressure spray application ensures even distribution and strong bonding to the composite panel.
Available in various textures and finishes, including smooth or textured surfaces for grip-enhancing properties.
Coating thickness can be adjusted based on performance requirements.

### E. Edge Protection and Finishing:

The coating can seamlessly extend over panel edges to prevent delamination or moisture infiltration.
Optional reinforced edges for structural applications.

Following are key features and benefits of the disclosed high impact and penetration resistant lightweight composite panels.

### 1. Impact and Abrasion Resistance:

The spray-applied impact and penetration resistant coating provides superior protection against dents, scratches, and heavy impacts, extending the panel's lifespan.

### 2. Waterproof and Mold-Resistant:

The non-porous surface creates a fully sealed, waterproof layer, making the panels ideal for wet environments and outdoor applications.
Prevents moisture absorption, reducing the risk of mold and mildew growth.

### 3. Slip-Resistant Surface:

The inclusion of non-slip additives provides a high-traction surface, making it ideal for work areas, utility shelves, and high-traffic applications.
Reduces slip hazards in wet or industrial environments, improving safety and usability.

### 4. Lightweight Yet Structurally Strong:

Combines a lightweight core with a high-durability outer layer, maintaining an exceptional strength-to-weight ratio.
Easier to install and handle compared to metal, wood, or heavy composite materials.

### 5. Versatile Aesthetic and Functional Finishes:

The textured finish provides a pleasing aesthetic providing options for both industrial and architectural applications.
Non-slip textures make it ideal for shelving, partitions, and work surfaces.

### 6. Enhanced Chemical and UV Resistance:

The coating is resistant to oils, chemicals, and UV degradation, ensuring long-lasting durability in industrial and outdoor environments.

Following are potential applications of the disclosed high impact and penetration resistant lightweight composite panels.

### 1. Utility and Industrial Shelving:

Waterproof, impact-resistant, and non-slip storage panels for warehouses, garages, and industrial workspaces.

### 2. Durable Interior and Exterior Wall Panels:

High-strength partitions and decorative panels for commercial spaces, hospitals, garages and public facilities.

### 3. Vehicle and Marine Applications:

Impact-resistant, slip-resistant interior panels, flooring, and partitions for vans, trailers, and boats.

### 4. Outdoor and Recreational Uses:

Weatherproof, non-slip panels for outdoor furniture, exterior walls, or structural components.

### 5. Modular Construction and Temporary Structures:

Lightweight yet durable panels for portable buildings, rapid construction projects, and emergency shelters.

Following is a summary of novel aspects and improvements provided by the disclosed high impact and penetration resistant lightweight composite panels.

### 1. Coated Composite Panel System:

A lightweight panel with a Spray-Applied Impact and penetration resistant Coating containing non-slip additives for improved impact resistance, waterproofing, and overall durability.

### 2. Material and Composition:

The composite panels can include various core materials (e.g., XPS, polyurethane foam, cementitious panels) combined with polyurethane/polyurea protective coatings with or without integrated slip-resistant additives.

### 3. Manufacturing and Application Process:

Spray-applied high-strength elastomeric coating for seamless adhesion and extended panel life.
Variations in coating thickness, texture, and slip-resistant finishes for different end uses.

### 4. Performance Enhancements:

Abrasion, chemical, and UV resistance for long-term performance.
Structural integrity while maintaining lightweight characteristics.
Enhanced safety with integrated slip-resistant surface properties.

### 5. Versatile Use Cases:

Product can be used for multiple applications, including utility shelving, partitions, vehicle panels, slip-resistant flooring, and exterior wall cladding or sheathing.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. An impact and penetration resistant lightweight composite panel, comprising:
a polymer and/or inorganic foam core having a first surface, a second surface opposite the first surface, and a thickness in a range of about 0.4 cm to about 5 cm; and
an impact and penetration resistant protective layer formed on or positioned over at least one of the first surface or the second surface of the foam core, the impact and penetration resistant protective layer comprising:
at least one protective material selected from thermoset polymer, polyaspartic, polyurea, polyurethane, polyurea-polyurethane hybrid, polymer-modified mineral binder, hybrid resin-mineral composite, and mineral binder; and
optionally a tightly woven fabric or scrim at least partially embedded within the protective material, provided that where the protective material is a mineral binder, the tightly woven fabric or scrim is included,
wherein the impact and penetration resistant protective layer has a thickness in a range of about 1 mm to about 10 mm.

2. The impact and penetration resistant lightweight composite panel of claim 1, wherein the foam core comprises a polymer foam selected from extruded polystyrene (XPS) foam, polyisocyanurate foam, polyurethane (PUR) foam, phenolic polymer foam, phenol-formaldehyde foam, melamine polymer foam, melamine-formaldehyde foam, and expanded polystyrene (EPS) foam.

3. The impact and penetration resistant lightweight composite panel of claim 1, wherein the foam core comprises an inorganic material selected from perlite, expanded perlite spheres or microspheres, vermiculite, pumice, ceramic microspheres, hollow glass spheres, glass foam, ceramic foam, expanded silica gel, aerogel, silicate foam, porous wollastonite, metakaolin, urea-silicate foam, SiOC/SiC foam, refractory foam, and graphene.

4. The impact and penetration resistant lightweight composite panel of claim 1, wherein the foam core has a thickness in a range of about 0.5 cm to about 4.5 cm, or about 0.75 cm to about 4 cm, or about 1 cm to about 3.5 cm, or about 1.5 cm to about 3 cm.

5. The impact and penetration resistant lightweight composite panel of claim 1, wherein the impact and penetration resistant protective layer further comprises a tightly woven fabric or scrim at least partially embedded within the at least one protective material, wherein the tightly woven fabric or scrim includes at least one of alkali-resistant (AR) fiberglass, high-count fiberglass, AR polyester, aramid fibers, including para-aramid fibers, ultrahigh molecular weight polyethylene (UHMW-PE) fibers, poly(p-phenylene-2,6-benzobisoxazole (PBO) fibers, carbon fibers, nylon or polyamide fibers, or hybrid fiber architectures with multiple fiber types.

6. The impact and penetration resistant lightweight composite panel of claim 1, wherein the impact and penetration resistant protective layer further comprises a slip resistant filler at least partially embedded within the at least one protective material, wherein the slip resistant filler includes at least one of silica granules, aluminum oxide grit, or rubberized particles and provides a textured, slip-resistant surface for increased traction.

7. The impact and penetration resistant lightweight composite panel of claim 1, wherein the impact and penetration resistant protective layer has a thickness in a range of about 1.25 mm to about 8.75 mm, or about 1.5 mm to about 7.5 mm, or about 2 mm to about 6 mm.

8. The impact and penetration resistant lightweight composite panel of claim 1, wherein the lightweight composite panel comprises a first impact and penetration resistant protective layer formed on and in contact with the first surface of the foam core, a second impact and penetration resistant protective layer formed on and in contact with the second surface of the foam core, and optionally the protective material formed on and in contact with one or more side surfaces of the foam core.

9. The impact and penetration resistant lightweight composite panel of claim 1, further comprising at least one fiber mesh reinforced cementitious layer formed on and in contact with at least one of the first surface or the second surface of the foam core.

10. The impact and penetration resistant lightweight composite panel of claim 9, wherein the lightweight composite panel includes the impact and penetration resistant protective layer formed on and in contact with the first surface of the foam core and the fiber mesh reinforced cementitious layer formed on and in contact with the second surface of the foam core.

11. The impact and penetration resistant lightweight composite panel of claim 9, wherein the lightweight composite panel includes a first fiber mesh reinforced cementitious layer formed on and in contact with the first surface of the foam core, a second fiber mesh reinforced cementitious layer formed on and in contact with the second surface of the foam core, a first impact and penetration resistant protective layer formed on and in contact with the first fiber mesh reinforced cementitious layer, and optionally a second impact and penetration resistant protective layer formed on and in contact with the second fiber mesh reinforced cementitious layer.

12. The impact and penetration resistant lightweight composite panel of claim 9, wherein each fiber mesh reinforced cementitious layer includes a hardened cementitious composition comprising mixture products of hydraulic cement, fine aggregate, mineral additive, chemical admixture, and water.

13. The impact and penetration resistant lightweight composite panel of claim 9, wherein each fiber mesh reinforced cementitious layer has a cross-sectional thickness of about 0.25 mm to about 3 mm, or about 0.4 mm to about 2.5 mm, or about 0.5 mm to about 2 mm, or about 0.75 mm to about 1.5 mm, or about 1 mm.

14. An impact and penetration resistant lightweight composite panel, comprising:
a polymer and/or inorganic foam core having a first surface, a second surface opposite the first surface, and a thickness in a range of about 0.4 cm to about 5 cm; and
an impact and penetration resistant protective layer formed on and in contact with at least one of the first surface or the second surface of the foam core, the impact and penetration resistant protective layer comprising:
at least one protective material selected from thermoset polymer, polyaspartic, polyurea, polyurethane, polyurea-polyurethane hybrid, polymer-modified mineral binder, hybrid resin-mineral composite, and mineral binder; and
a tightly woven fabric or scrim at least partially embedded within the protective material, provided that where the protective material is a mineral binder, the tightly woven fabric or scrim is included,
wherein the impact and penetration resistant protective layer has a thickness in a range of about 1 mm to about 10 mm.

15. The impact and penetration resistant lightweight composite panel of claim 14, wherein the lightweight composite panel comprises a first impact and penetration resistant protective layer formed on and in contact with the first surface of the foam core, a second impact and penetration resistant protective layer formed on and in contact with the second surface of the foam core, and the protective material formed on and in contact with one or more side surfaces of the foam core.

16. The impact and penetration resistant lightweight composite panel of claim 14, wherein the lightweight composite panel comprises a single impact and penetration resistant protective layer formed on and in contact with the first surface of the foam core and a fiber mesh reinforced cementitious or other protective layer formed on and in contact with the second surface of the foam core.

17. An impact and penetration resistant lightweight composite panel, comprising:
a polymer and/or inorganic foam core having a first surface, a second surface opposite the first surface, and a thickness in a range of about 0.4 cm to about 5 cm;
a first fiber mesh reinforced cementitious or other protective layer formed on and in contact with the first surface of the foam core;
a second fiber mesh reinforced cementitious or other protective layer formed on and in contact with the first surface of the foam core; and
an impact and penetration resistant protective layer formed on and in contact with at least one of the first or second fiber mesh reinforced cementitious or other protective layers, the impact and penetration resistant protective layer comprising:
at least one protective material selected from thermoset polymer, polyaspartic, polyurea, polyurethane, polyurea-polyurethane hybrid, polymer-modified mineral binder, hybrid resin-mineral composite, and mineral binder; and
optionally a tightly woven fabric or scrim at least partially embedded within the protective material, provided that where the protective material is a mineral binder, the tightly woven fabric or scrim is included,
wherein the impact and penetration resistant protective layer has a thickness in a range of about 1 mm to about 10 mm.

18. The impact and penetration resistant lightweight composite panel of claim 17, wherein the first and second fiber mesh reinforced cementitious or other protective layers each has a cross-sectional thickness of about 0.25 mm to about 3 mm, or about 0.4 mm to about 2.5 mm, or about 0.5 mm to about 2 mm, or about 0.75 mm to about 1.5 mm, or about 1 mm.

19. A method of manufacturing the impact and penetration resistant lightweight composite panel of claim 1, comprising:
providing the foam core having the first and second surfaces;
optionally applying at least one fiber mesh reinforced cementitious or other protective layer to at least one of the first or second surfaces of the foam core; and
spray-coating one or more layers of a curable composition to form one or more impact and penetration resistant protective layers in contact with the foam core and/or the optionally applied at least one fiber mesh reinforced cementitious or other protective layer.

20. A method of using the impact and penetration resistant lightweight composite panel of claim 1, comprising attaching or positioning one or more of the impact and penetration resistant lightweight composite panels to form one or more of the following:
industrial or residential shelving;
building flooring;
exterior wall sheathing;
exterior wall paneling;
interior wall paneling;
paneling, flooring, or partitions for vans, trailers or boats;
patio or other outdoor flooring, walls, or structural components; or
modular walls, flooring, and dividers for modular construction or temporary structures.
